(19) United States
(12) Patent Application Publication
(10) Pub. No.: US 2026/0223053 A1
(43) Pub. Date: Jul. 30, 2026

(54) METHODS AND APPARATUSES FOR SIDELINK POSITIONING

(71) Applicant: LENOVO (BEIJING) LIMITED, Beijing (CN)

(72) Inventors: Jing Han, Beijing (CN); Jie Hu, Beijing (CN); Luning Liu, Beijing (CN); Lihua Yang, Beijing (CN); Haiming Wang, Beijing (CN)

(21) Appl. No.: 19/148,437

(22) PCT Filed: Jan. 17, 2023
(86) PCT No.: PCT/CN2023/072697

§ 371 Date: Jul. 16, 2025

(51) Int. Cl. H04W 64/00; H04W 48/16

(52) U.S. Cl. CPC H04W 64/00; H04W 48/16

(57) ABSTRACT

Embodiments of the present disclosure relate to methods and apparatuses for sidelink (SL) positioning. According to an embodiment of the present disclosure, a second user equipment (UE) can include: a transceiver; and a processor coupled to the transceiver and configured to: establish a sidelink (SL) positioning protocol (SLPP) session with a first UE and one or more other second UEs; and groupcast or unicast, with the transceiver, a capability message to the first UE, wherein the capability message indicates SL positioning capability information of the second UE.

### TECHNICAL FIELD

Embodiments of the present application generally relate to wireless communication technologies, and especially to methods and apparatuses for sidelink (SL) positioning.

### BACKGROUND

A sidelink is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

SL positioning refers to transmitting positioning reference signal (PRS) over SL, which can operate independently of network or radio access technology (RAT) coverage and provide a new positioning method that fits new network use cases. Currently, details regarding group SL positioning need to be further discussed.

### SUMMARY OF THE APPLICATION

Embodiments of the present application at least provide technical solutions for SL positioning.

According to some embodiments of the present application, a first UE may include: a transceiver; and a processor coupled to the transceiver and configured to: establish an SL positioning protocol (SLPP) session with multiple second UEs; and receive, with the transceiver, multiple capability messages from the multiple second UEs, wherein each capability message in the multiple capability messages indicates SL positioning capability information of a corresponding second UE in the multiple second UEs.

In some embodiments of the present application, each capability message in the multiple capability messages includes at least one of: an identity (ID) of the corresponding second UE; an ID of the first UE; an ID of an SLPP transaction within the SLPP session; or an ID of the SLPP session.

In some embodiments of the present application, the processor is further configured to groupcast, with the transceiver, a capability request message for requesting the SL positioning capability information of each of the multiple second UEs, and the capability request message includes at least one of: an ID of the first UE; an ID of an SLPP transaction within the SLPP session; an ID of the SLPP session; or a response time within which each of the multiple second UEs is required to respond with the SL positioning capability information.

In some embodiments of the present application, the processor is further configured to: groupcast, with the transceiver, an assistance data message including one or more sets of assistance data to the multiple second UEs, wherein each set of assistance data indicates a corresponding configuration of a corresponding positioning method.

In some embodiments of the present application, each set of assistance data includes a same SLPP transaction ID, and is associated with an ID to differentiate each set of assistance data in the same SLPP transaction.

In some embodiments of the present application, the processor is further configured to: receive, with the transceiver and from at least one second UE of the multiple second UEs, at least one assistance data request message for requesting configuration(s) of positioning method(s); and generate the one or more sets of assistance data based on the at least one assistance data request message.

In some embodiments of the present application, the processor is further configured to: receive, with the transceiver, an indication from a second UE other than the at least one second UE, wherein the indication indicates that the one or more sets of assistance data are not suitable for the second UE or includes an additional assistance data request message for requesting configuration(s) of positioning method(s) for the second UE; and groupcast, with the transceiver, an additional assistance data message including one or more additional sets of assistance data or transmit, with the transceiver, an indication indicating that no new assistance data can be provided to the second UE.

In some embodiments of the present application, each additional set of assistance data indicates a corresponding configuration of a corresponding positioning method requested by the additional assistance data request message.

In some embodiments of the present application, the processor is further configured to: generate the one or more sets of assistance data based on the multiple capability messages from the multiple second UEs; or trigger a transmission of the one or more sets of assistance data in response to receiving capability message(s) from all of the multiple second UEs or in response to a finish of an SLPP transaction for capability transfer in the SLPP session.

In some embodiments of the present application, the processor is further configured to: groupcast or broadcast, with the transceiver and according to the one or more sets of assistance data, one or more sets of SL-PRSs to the multiple second UEs.

In some embodiments of the present application, the processor is further configured to: receive, with the transceiver, at least one indication from at least one second UE of the multiple second UEs within a time period after a start of a transmission of the one or more sets of SL-PRSs; wherein each indication of the at least one indication indicates a finish of SL-PRS measurement or position calculation of a corresponding second UE; and wherein the time period is configured by the first UE or inferred from a location service quality of service (QoS) requirement or pre-configured or pre-defined.

In some embodiments of the present application, the processor is further configured to determine a location failure for a second UE in the case that the transceiver does not receive an indication indicating a finish of SL-PRS measurement or position calculation from the second UE within the time period.

In some embodiments of the present application, the processor is further configured to transmit, with the transceiver, an indication indicating an end time of a transmission of the one or more sets of SL-PRSs to the multiple second UEs.

In some embodiments of the present application, the processor is further configured to determine that the SLPP session is terminated in response to at least one of the following: a stop of a transmission of the one or more sets of SL-PRSs; receiving indication(s) indicating a finish of SL-PRS measurement or position calculation from all of the multiple second UEs; or determining that all of the multiple second UEs have finished SL-PRS measurement or position calculation.

In some embodiments of the present application, the processor is further configured to: receive, with the transceiver, a capability message from a third UE after the third UE joined the SLPP session, wherein the capability message includes an ID of the third UE; and in response to receiving the capability message, groupcast or unicast, with the transceiver, assistance data associated with the SLPP session to the third UE.

In some embodiments of the present application, the processor is further configured to: groupcast or unicast, with the transceiver, assistance data associated with the SLPP session to a third UE after the third UE joined the SLPP session.

According to some embodiments of the present application, a second UE may include: a transceiver; and a processor coupled to the transceiver and configured to: establish an SLPP session with a first UE and one or more other second UEs; and groupcast or unicast, with the transceiver, a capability message to the first UE, wherein the capability message indicates SL positioning capability information of the second UE.

In some embodiments of the present application, the capability message includes at least one of: an ID of the second UE; an ID of the first UE; an ID of an SLPP transaction within the SLPP session; or an ID of the SLPP session.

In some embodiments of the present application, the processor is further configured to receive, with the transceiver, a capability request message groupcast from the first UE for requesting the SL positioning capability information, and the capability request message includes at least one of: an ID of the first UE; an ID of an SLPP transaction within the SLPP session; an ID of the SLPP session; or a response time within which the second UE is required to respond with the SL positioning capability information.

In some embodiments of the present application, the processor is further configured to trigger a transmission of the capability message in response to at least one of the following: receiving an indication from an upper layer indicating an establishment of the SLPP session or an establishment of a group including the first UE and the second UE; or joining the SLPP session or the group; or wherein the capability message is transmitted via a discovery message associated with a discovery procedure between the first UE and the second UE.

In some embodiments of the present application, the processor is further configured to: receive, with the transceiver, an assistance data message including one or more sets of assistance data groupcast from the first UE, wherein each set of assistance data indicates a corresponding configuration of a corresponding positioning method.

In some embodiments of the present application, each set of assistance data includes a same SLPP transaction ID, and is associated with an ID to differentiate each set of assistance data in the same SLPP transaction.

In some embodiments of the present application, the processor is further configured to: transmit, with the transceiver and to the first UE, an assistance data request message for requesting configuration(s) of positioning method(s).

In some embodiments of the present application, the processor is further configured to trigger a transmission of the assistance data request message in response to an SLPP transaction for capability transfer in the SLPP session being finished.

In some embodiments of the present application, the processor is further configured to determine at least one set of assistance data from the one or more sets of assistance data that is suitable for the second UE or matches the assistance data request message transmitted by the second UE.

In some embodiments of the present application, in the case that the one or more sets of assistance data are not suitable for the second UE, the processor is further configured to: indicate the one or more sets of assistance data to an upper layer for determining to use at least one set of assistance data of the one or more sets of assistance data; or transmit, with the transceiver, an indication to the first UE, wherein the indication indicates that the one or more sets of assistance data are not suitable for the second UE or includes an assistance data request message for requesting configuration(s) of positioning method(s) for the second UE.

In some embodiments of the present application, the processor is further configured to: receive, with the transceiver, an addition assistance data message including one or more additional sets of assistance data groupcast from the first UE or an indication indicating that no new assistance data can be provided to the second UE.

In some embodiments of the present application, each additional set of assistance data indicates a corresponding configuration of a corresponding positioning method requested by the additional assistance data request message.

In some embodiments of the present application, the processor is further configured to: receive, with the transceiver, one or more sets of SL-PRSs groupcast or broadcast from the first UE according to the one or more sets of assistance data; and measure SL-PRS according to configuration(s) of positioning method(s) in set(s) of assistance data suitable for the second UE and calculate a position of the second UE according to SL-PRS measurement result(s) and the set(s) of assistance data suitable for the second UE.

In some embodiments of the present application, the processor is further configured to: transmit, with the transceiver, an indication to the first UE within a time period after a start of a transmission of the one or more sets of SL-PRSs; wherein the indication indicates a finish of SL-PRS measurement or position calculation of the second UE; and wherein the time period is configured by the first UE or inferred from a location service QoS requirement or pre-configured or pre-defined.

In some embodiments of the present application, the processor is further configured to receive, with the transceiver, an indication indicating an end time of a transmission of the one or more sets of SL-PRSs, and stop measuring SL-PRS at the end time.

In some embodiments of the present application, the processor is further configured to determine that the SLPP session is terminated in response to a stop of a transmission of the one or more sets of SL-PRSs.

In some embodiments of the present application, establishing the SLPP session with the first UE and the one or more other second UEs includes joining an SLPP session previously established between the first UE and the one or more other second UEs, the capability message includes an ID of the second UE, and the processor is further configured to: receive, with the transceiver, assistance data associated with the previously established SLPP session groupcast or unicast from the first UE in response to the capability message.

In some embodiments of the present application, the processor is further configured to determine whether the assistance data is suitable for the second UE and a location service QoS requirement; in the case that the assistance data is suitable, the processor is further configured to measure SL-PRS according to the assistance data; and in the case that the assistance data is not suitable, the processor is further configured to: transmit, with the transceiver, an indication to the first UE, wherein the indication indicates that the assistance data is not suitable or requests new assistance data.

According to some embodiments of the present application, a method performed by a first UE may include: establishing an SLPP session with multiple second UEs; and receiving multiple capability messages from the multiple second UEs, wherein each capability message in the multiple capability messages indicates SL positioning capability information of a corresponding second UE in the multiple second UEs.

According to some embodiments of the present application, a method performed by a second UE, comprising: establishing an SLPP session with a first UE and one or more other second UEs; and groupcast or unicast, with the transceiver, a capability message to the first UE, wherein the capability message indicates SL positioning capability information of the second UE.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIGS. 2 and 3 illustrate exemplary capability transfer procedures according to some embodiments of the present application;

FIGS. 4 and 5 illustrate exemplary assistance data transfer procedures according to some embodiments of the present application;

FIG. 6 illustrates an exemplary location calculation procedure according to some embodiments of the present application;

FIG. 7 illustrates an exemplary procedure for group change according to some embodiments of the present application; and

FIG. 8 illustrates a simplified block diagram of an exemplary apparatus for SL positioning according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order shown or in sequential order, or that among all illustrated operations to be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3GPP LTE, LTE-advanced, 5G (i.e., new radio (NR)), 5G-advanced, 6G, and so on. Persons skilled in the art know very well that, with the development of network architecture and new service scenarios, the embodiments in the present application are also applicable to similar technical problems; and moreover, the terminologies recited in the present application may change, which should not affect the principle of the present application.

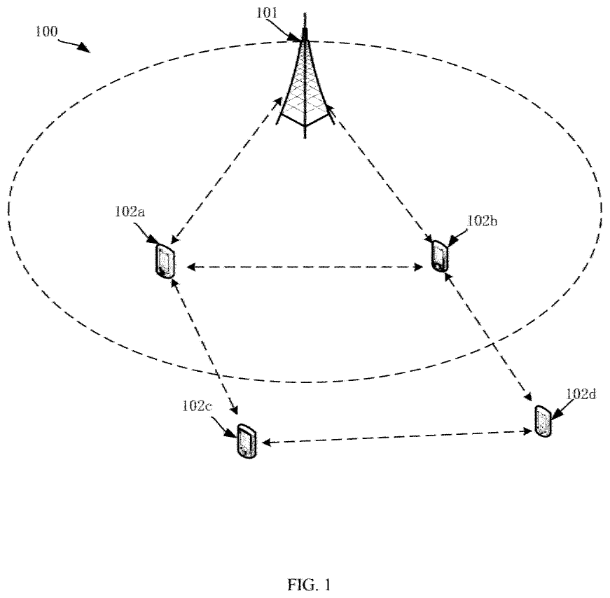

FIG. 1 is a schematic diagram illustrating an exemplary wireless communication system 100 according to some embodiments of the present application.

As shown in FIG. 1, the wireless communication system 100 includes at least one BS 101 and at least one UE (e.g., a UE 102a, a UE 102b, a UE 102c, and a UE 102d). Although one BS and four UEs are depicted in FIG. 1 for illustrative purpose, it is contemplated that any number of BSs and UEs may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a node-B, an enhanced or evolved node B (eNB), a generalized node B (gNB), a home node-B, a relay node, or a device, or described using other terminology used in the art. The BS 101 is generally part of a radio access network that may include a controller communicably coupled to the BS 101.

According to some embodiments of the present application, the UE 102a, the UE 102b, the UE 102c, and the UE 102d may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE.

According to some other embodiments of the present application, the UE 102a, the UE 102b, the UE 102c, and the UE 102d may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102a, the UE 102b, the UE 102c, and the UE 102d may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102a, the UE 102b, the UE 102c, and the UE 102d may include wearable devices, such as smart watches, fitness bands, optical head-mounted displays, or the like.

Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 102a and the UE 102b in the embodiments of FIG. 1 are in a coverage area of the BS 101, and may transmit information or data to the BS 101 and receive control information or data from the BS 101, for example, via LTE or NR Uu interface.

The UE 102c and the UE 102d are outside the coverage area of the BS 101. The UE 102a may communicate with the UE 102b and the UE 102c via SL (for example, via PC5 interface as defined in 3GPP standard documents), and the UE 102d may communicate with the UE 102b and the UE 102c via SL.

With respect to the sidelink positioning procedures between UEs, SLPP is introduced to support at least the following functionalities: SL positioning capability transfer, SL positioning assistance data exchange, SL location information transfer, error handling, abort, etc.

The cast type for SLPP signaling may include unicast, groupcast and broadcast. Unicast/one-to-one operation may be assumed as baseline for exchange of SLPP signaling between UEs. Unicast SLPP session-based operation and “centralized” operation are both supported for SL positioning. For example, the “centralized” operation may refer to an operation where one UE performs range and/or position calculations based on measurement/location information relating to itself and/or other UEs.

For SLPP, a use case with multiple target UEs may exist. A target UE may be a UE whose position (or location) needs to be calculated or known. For a use case with multiple target UEs, both session-based and session-less SLPP procedures are possible. In a session-based SLPP procedure, multiple target UEs and one or more anchor UEs are in the same SLPP session (or in the same group). An anchor UE may be a UE which participates in SL positioning and helps the target UE to acquire its position, e.g., by sending/receiving SL-PRS and doing relevant measurements. There may be one location request and SLPP messages in the SLPP session are associated with the location request, and multiple target UEs in the SLPP session may calculate their positions. In a session-less SLPP procedure, no session is established, and SLPP messages are public messages for all group members in the group, or public for surrounding UEs. SL positioning in the above use case may also be referred to as group SL positioning or distributed SL positioning.

The group SL positioning with session-based SLPP messages may involve the following issues.

Issue #1: how to design an SLPP procedure for multiple target UEs in an established SLPP session. For example, the SLPP procedure may include at least one of: capability transfer procedure, assistance data transfer procedure, location calculation procedure, and termination of an SLPP session.

As an example, in a legacy LTE positioning protocol (LPP) procedure, the capability transfer is one-to-one transmission, and includes two possible procedures: request based procedure and directly providing capability procedure. However, for SLPP, there may be multiple target UEs, and then how to transfer capability information between anchor UE(s) and multiple target UEs needs to be designed.

As another example, in a legacy LPP procedure, the assistance data transfer is one-to-one transmission, and includes two possible procedures: request based procedure and directly providing assistance data procedure. However, for SLPP, there may be multiple target UEs, and then how to transfer assistance data between anchor UE(s) and multiple target UEs needs to be designed.

As yet another example, in a legacy LPP procedure, location information may be requested by and sent to a location management function (LMF) from a target UE. In addition, UE-based positioning is also supported in the legacy LPP procedure, wherein the target UE may calculate its position. However, for SLPP, there may be multiple target UEs, and the locations may be calculated by multiple target UEs and whether to transfer location information to other network node(s) is not clear.

As yet another example, in a legacy LPP procedure, after the location information is acquired from a target UE, the LPP session can be terminated. However, for SLPP, there may be multiple target UEs, and then the legacy procedure may be no longer suitable.

Issue #2: what procedure may be performed to support new target UE(s) when the group members change or the SLPP session is modified.

For example, assuming that there is an already established SLPP session between multiple target UEs and multiple anchor UEs, and an SLPP procedure is ongoing, new target UE(s) may join the SLPP session or the group during the on-going SLPP procedure, and then whether to establish a new session for the new target UE(s), or continue to use the on-going session needs to be discussed. Moreover, if the on-going session is used for the new target UE(s), when the existing assistance data is not suitable for the new target UE(s), how to solve such problem needs to be discussed.

Given this, embodiments of the present application propose methods for SL positioning, which provide various technical solutions regarding capability transfer, assistance data transfer, location calculation, session termination, and procedure for group/session change for SLPP. Embodiments of the present application can at least solve the above problems. More details on embodiments of the present application will be described in the following text in combination with the appended drawings.

According to some embodiments of the present application, an SLPP session may be established among multiple target UEs and one or more anchor UEs. In other words, these UEs form a group and are associated with the same SLPP session. The SLPP session may be associated with one location request with QoS requirement(s) for a location service. The purpose of the location request is to calculate position (or ranging) for each target UE of the multiple target UEs. The following embodiments may provide several methods for capability transfer in the SLPP session, assistance data transfer in the SLPP session, location calculation in the SLPP session, SLPP session termination, and SLPP session (or group) change.

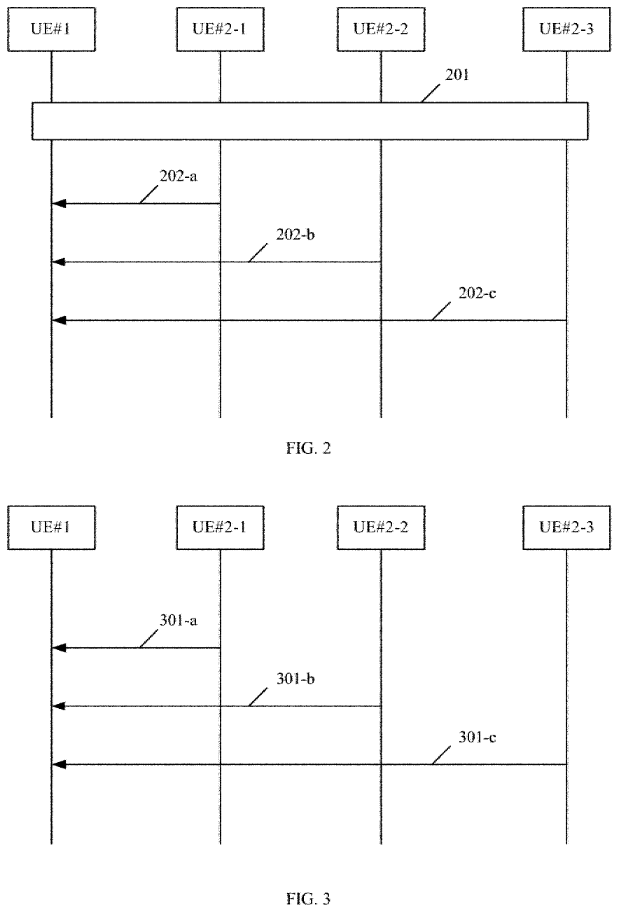

FIGS. 2 and 3 illustrate exemplary capability transfer procedures according to some embodiments of the present application.

The methods in the examples of FIGS. 2 and 3 may be performed by a first UE (e.g., UE #1) and one or more second UEs (e.g., UE #2-1, UE #2-2, and UE #2-3). The first UE may refer to an initiator UE which triggers a procedure, such as a group leader, a server UE, an anchor UE, an SL reference UE, or an SL positioning client UE. For example, an SL positioning client UE may be a third-party UE, other than an SL reference UE and a target UE, which initiates ranging or sidelink positioning service request on behalf of the application residing on it. The initiator UE may be determined by an upper layer (e.g. application layer). Each second UE may refer to a target UE whose position (or location) needs to be calculated or known. Although three second UEs are depicted in FIGS. 2 and 3 for illustrative purpose, it is contemplated that any number of second UEs may be involved in the procedures illustrated in FIGS. 2 and 3. Although the methods are illustrated in a system level by four UEs, persons skilled in the art can understand that the methods implemented in the first UE and in the three second UEs can be separately implemented and incorporated by other apparatus with the like functions.

Before the steps shown in FIGS. 2 and 3, the first UE (e.g., UE #1) and the one or more second UEs (e.g., UE #2-1, UE #2-2, and UE #2-3) may establish an SLPP session among them. That is, the first UE may establish an SLPP session with the one or more second UEs, or any second UE of the one or more second UEs may establish an SLPP session with the first UE and other second UE(s) in the one or more second UEs. In other words, the procedures illustrated in FIGS. 2 and 3 may occur in a case that an SLPP session has been established among the first UE and the one or more second UEs. That is, the first UE and the one or more second UEs are in a group and in the established SLPP session.

FIG. 2 illustrates a request based capability transfer procedure (also referred to as an SLPP transaction for capability transfer in the SLPP session).

In step 201, the first UE (e.g., UE #1) may groupcast a capability request message to the one or more second UEs (e.g., UE #2-1, UE #2-2, and UE #2-3). The capability request message may request SL positioning capability information of each of the one or more second UEs. The capability request message may include at least one of: an ID of the first UE; an ID of an SLPP transaction within the SLPP session; an ID of the SLPP session; or a response time within which each of the one or more second UEs is required to respond with the SL positioning capability information.

Consequently, in step 201, each second UE (e.g., UE #2-1, UE #2-2, and UE #2-3) may receive the capability request message groupcast from the first UE. In response to receiving the capability request message, each second UE may groupcast or unicast a corresponding capability message to the first UE. The corresponding capability message may indicate SL positioning capability information of a corresponding second UE. For example, in step 202-a, UE #2-1 may groupcast or unicast a capability message indicating SL positioning capability information of UE #2-1 to UE #1; in step 202-b, UE #2-2 may groupcast or unicast a capability message indicating SL positioning capability information of UE #2-2 to UE #1; in step 202-c, UE #2-3 may groupcast or unicast a capability message indicating SL positioning capability information of UE #2-3 to UE #1.

In some embodiments, the SL positioning capability information may include at least one of: supported positioning method of the corresponding second UE, supported bandwidth of the corresponding second UE, supported positioning configuration of the corresponding second UE, etc.

In some embodiments, the corresponding capability message may also include at least one of: an ID of the corresponding second UE; an ID of the first UE; an ID of an SLPP transaction within the SLPP session (which is the same as the ID of the SLPP transaction included in the capability request message); or an ID of the SLPP session.

In some embodiments, in the case that a response time is indicated in the capability request message, each second UE should transmit the corresponding capability message within the response time.

Consequently, the first UE may receive one or more capability messages from the one or more second UEs.

FIG. 3 illustrates a capability transfer procedure in which the second UE(s) directly provide capability message(s) to the first UE without receiving any request from the first UE.

In FIG. 3, each second UE (e.g., UE #2-1, UE #2-2, and UE #2-3) may groupcast or unicast a corresponding capability message to the first UE (e.g., UE #1) without receiving any request from the first UE. For example, in step 301-a, UE #2-1 may transmit a capability message to UE #1; in step 301-b, UE #2-2 may transmit a capability message to UE #1; in step 301-c, UE #2-3 may transmit a capability message to UE #1.

The corresponding capability message may indicate SL positioning capability information of a corresponding second UE. The definitions regarding SL positioning capability information provided above with respect to FIG. 2 may also apply here.

In some embodiments, the corresponding capability message may also include at least one of: an ID of the corresponding second UE; an ID of the first UE; an ID of an SLPP transaction within the SLPP session; or an ID of the SLPP session.

In some embodiments, a second UE may trigger a transmission of the corresponding capability message in response to at least one of: the second UE receiving an indication from an upper layer (e.g., an application layer) indicating an establishment of the SLPP session or an establishment of the group; or the second UE joining the SLPP session or the group.

In some embodiments, the corresponding capability message may be transmitted via a discovery message associated with a discovery procedure between the first UE and the corresponding second UE. That is, the information included in the corresponding capability message may be included in the discovery message transmitted from the corresponding second UE to the first UE.

Consequently, the first UE may receive one or more capability messages from the one or more second UEs.

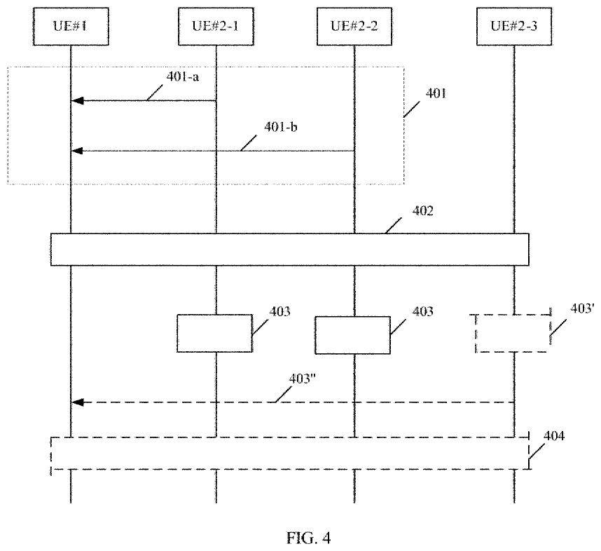

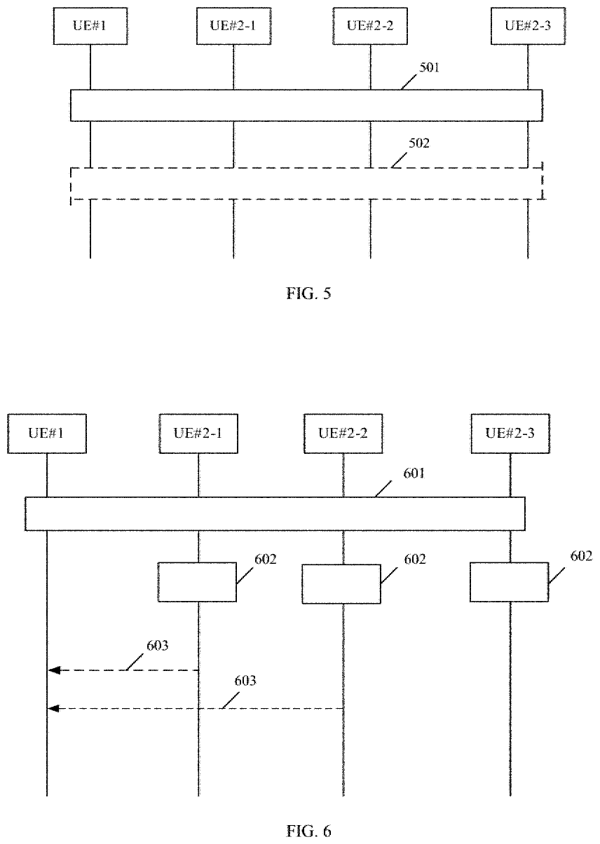

FIGS. 4 and 5 illustrate exemplary assistance data transfer procedures according to some embodiments of the present application.

The methods in the examples of FIGS. 4 and 5 may be performed by a first UE (e.g., UE #1) and one or more second UEs (e.g., UE #2-1, UE #2-2, and UE #2-3). The first UE may refer to an initiator UE which triggers a procedure, such as a group leader, a server UE, an anchor UE, an SL reference UE, or an SL positioning client UE. The initiator UE may be determined by an upper layer (e.g. application layer). Each second UE may refer to a target UE whose position (or location) needs to be calculated or known. Although three second UEs are depicted in FIGS. 4 and 5 for illustrative purpose, it is contemplated that any number of second UEs may be involved in the procedures illustrated in FIGS. 4 and 5. Although the methods are illustrated in a system level by four UEs, persons skilled in the art can understand that the methods implemented in the first UE and in the three second UEs can be separately implemented and incorporated by other apparatus with the like functions.

Before the steps shown in FIGS. 4 and 5, the first UE (e.g., UE #1) and the one or more second UEs (e.g., UE #2-1, UE #2-2, and UE #2-3) may establish an SLPP session among them. That is, the first UE may establish an SLPP session with the one or more second UEs, or any second UE of the one or more second UE may establish an SLPP session with the first UE and other second UE(s) in the one or more second UEs. In other words, the procedures illustrated in FIGS. 4 and 5 may occur in a case that an SLPP session has been established among the first UE and the one or more second UEs. That is, the first UE and the one or more second UEs are in a group and in the established SLPP session.

FIG. 4 illustrates a request based assistance data transfer procedure (also referred to as an SLPP transaction for assistance data transfer in the SLPP session).

In step 401, at least one second UE (e.g., UE #2-1 and UE #2-2) of the one or more second UEs (e.g., UE #2-1, UE #2-2, and UE #2-3) may transmit (e.g., groupcast or unicast) at least one assistance data request message requesting configuration(s) of positioning method(s) to the first UE, wherein each second UE of the at least one second UE may transmit a corresponding assistance data request message to the first UE. For example, a positioning method may refer to: round trip time (RTT) type solutions using SL, SL angle-of-arrival (AoA), SL time difference-of-arrival (TDOA), SL angle-of-departure (AoD), etc. A second UE may support one or more positioning methods.

For example, in step 401-a, UE #2-1 may transmit (e.g., groupcast or unicast) an assistance data request message requesting configuration(s) of positioning method(s) supported by UE #2-1 to the first UE. In step 401-b, UE #2-2 may transmit (e.g., groupcast or unicast) an assistance data request message requesting configuration(s) of positioning method(s) supported by UE #2-2 to the first UE.

In some embodiments, a second UE may trigger a transmission of the assistance data request message in response to an SLPP transaction for capability transfer (e.g., the procedure illustrated in FIG. 2 or 3) in the SLPP session being finished.

Consequently, in step 401, the first UE may receive at least one assistance data request message from the at least one second UE.

In response to receiving the at least one assistance data request message, in step 402, the first UE (e.g., UE #1) may groupcast an assistance data message including one or more sets of assistance data to the one or more second UEs (e.g., UE #2-1, UE #2-2, and UE #2-3). Each set of assistance data may indicate a corresponding configuration of a corresponding positioning method.

In some embodiments, the first UE may generate the one or more sets of assistance data based on the at least one assistance data request message. For example, the one or more sets of assistance data may indicate configuration(s) of positioning method(s) requested by the at least one assistance data request message, wherein each set of assistance data may indicate a corresponding configuration of a corresponding positioning method requested by the at least one assistance data request message.

In some cases, each set of assistance data includes a same SLPP transaction ID, and is associated with (e.g., include) an ID to differentiate each set of assistance data in the same SLPP transaction.

Accordingly, in step 402, each of the one or more second UEs (e.g., UE #2-1, UE #2-2, and UE #2-3) may receive the one or more sets of assistance data.

As an example, in step 403, a second UE may determine at least one set of assistance data from the one or more sets of assistance data that is suitable (or useable) for the second UE or matches the assistance data request message transmitted by the second UE. For example, the at least one set of assistance data determined by the second UE may indicate configuration(s) of positioning method(s) supported by the second UE. Although FIG. 4 only shows that UE #2-1 and UE #2-2, which transmitted assistance data request messages in step 401, perform step 403, it is contemplated that a second UE did not transmit an assistance data request message in step 401 may also determine at least one set of assistance data from the one or more sets of assistance data that is suitable for the second UE in some cases.

As another example, if a second UE (e.g., UE #2-3) which did not transmit an assistance data request message in step 401 cannot determine a suitable set of assistance data from the one or more sets of assistance data, in other words, the one or more sets of assistance data are not suitable (or useable) for the second UE, in step 403′, the second UE may indicate the one or more sets of assistance data to an upper layer (e.g., an application layer), and the upper layer may determine to use at least one set of assistance data of the one or more sets of assistance data.

As yet another example, if the one or more sets of assistance data are not suitable (or useable) for a second UE (e.g., UE #2-3), the second UE may transmit (e.g., unicast or groupcaset) an indication to the first UE in step 403″. The indication may indicate that the one or more sets of assistance data are not suitable for the second UE or include an additional assistance data request message for requesting configuration(s) of positioning method(s) for the second UE.

After receiving the indication, in some embodiments, in step 404, the first UE may groupcast an additional assistance data message including one or more additional sets of assistance data to the second UE. In the case that the indication includes an additional assistance data request message for requesting configuration(s) of positioning method(s) for the second UE, each additional set of assistance data may indicate a corresponding configuration of a corresponding positioning method requested by the additional assistance data request message. In some other embodiments, in step 404, the first UE may transmit (e.g., groupcast or unicast) an indication to the second UE indicating that no new assistance data can be provided to the second UE.

In the case that the additional assistance data message is received, the second UE may determine at least one set of assistance data from the one or more additional sets of assistance data that is suitable (or useable) for the second UE.

FIG. 5 illustrates an assistance data transfer procedure in which the first UE directly provide assistance data to the one or more second UEs without receiving any request from the one or more second UEs.

In step 501, the first UE (e.g., UE #1) may groupcast an assistance data message including one or more sets of assistance data to the one or more second UEs (e.g., UE #2-1, UE #2-2, and UE #2-3) without receiving any request from the one or more second UEs. Each set of assistance data may indicate a corresponding configuration of a corresponding positioning method. Each set of assistance data may include a same SLPP transaction ID, and may be associated with (e.g., include) an ID to differentiate different sets of assistance data in the same SLPP transaction.

In some embodiments, the first UE may generate the one or more sets of assistance data based on one or more capability messages from the one or more second UEs (e.g., received in any of steps 202-a, 202-b, 202-c, 301-a, 301-b, and 301-c). For example, the one or more capability messages may indicate positioning method(s) supported by the one or more second UEs. The one or more sets of assistance data may indicate configuration(s) of positioning method(s) indicated by the one or more capability messages, wherein each set of assistance data may indicate a corresponding configuration of a corresponding positioning method indicated by the one or more capability messages.

In some embodiments, the first UE may trigger a transmission of the one or more sets of assistance data in response to receiving capability message(s) from all of the one or more second UEs or in response to a finish of an SLPP transaction for capability transfer (the procedure illustrated in FIG. 2 or 3) in the SLPP session.

In some embodiments of FIG. 5, the configuration(s) of positioning method(s) indicated by the one or more sets of assistance data may be not supported by all of the one or more second UEs. In other words, the one or more sets of assistance data may be not suitable for at least one second UE of the one or more second UEs. In such embodiments, the first UE may groupcast an additional assistance message including one or more additional sets of assistance data to the one or more second UEs in step 502. For example, the first UE may groupcast the additional assistance message in response to at least one indication received from the at least one second UE, wherein each indication may indicate that the one or more sets of assistance data are not suitable for a corresponding second UE or include an additional assistance data request message for requesting configuration(s) of positioning method(s) for the corresponding second UE. In some other embodiments, the first UE may transmit (e.g., groupcast or unicast) an indication to the at least one second UE indicating that no new assistance data can be provided to the at least one second UE.

In the case that the additional assistance data message is received, the at least one second UE may determine at least one set of assistance data from the one or more additional sets of assistance data that is suitable (or useable) for the at least one second UE.

FIG. 6 illustrates an exemplary location calculation procedure according to some embodiments of the present application.

The method illustrated in FIG. 6 may be performed by a first UE (e.g., UE #1) and one or more second UEs (e.g., UE #2-1, UE #2-2, and UE #2-3). The first UE may refer to an initiator UE which triggers a procedure, such as a group leader, a server UE, an anchor UE, an SL reference UE, or an SL positioning client UE. The initiator UE may be determined by an upper layer (e.g. application layer). Each second UE may refer to a target UE whose position (or location) needs to be calculated or known. Although three second UEs are depicted in FIG. 6 for illustrative purpose, it is contemplated that any number of second UEs may be involved in the procedure illustrated in FIG. 6. Although the method is illustrated in a system level by four UEs, persons skilled in the art can understand that the method implemented in the first UE and that implemented in the three second UEs can be separately implemented and incorporated by other apparatus with the like functions.

Before the steps shown in FIG. 6, the first UE (e.g., UE #1) and the one or more second UEs (e.g., UE #2-1, UE #2-2, and UE #2-3) may establish an SLPP session among them. That is, the first UE may establish an SLPP session with the one or more second UEs, or any second UE of the one or more second UEs may establish an SLPP session with the first UE and other second UE(s) in the one or more second UEs. In other words, the procedure illustrated in FIG. 6 may occur in a case that an SLPP session has been established among the first UE and the one or more second UEs. That is, the first UE and the one or more second UEs are in a group and in the established SLPP session.

Referring to FIG. 6, in step 601, the first UE (e.g., UE #1) may groupcast or broadcast one or more sets of SL-PRSs to the one or more second UEs (e.g., UE #2-1, UE #2-2, and UE #2-3). The one or more sets of SL-PRSs may be transmitted according to one or more sets of assistance data (and one or more additional sets of assistance data in some cases) (e.g., which are transmitted in any of steps 402, 404, 501, and 502). For example, each set of SL-PRSs may be transmitted according to a corresponding set of assistance data.

In step 602, each second UE of the one or more second UEs (e.g., UE #2-1, UE #2-2, and UE #2-3) may measure SL-PRS according to configuration(s) of positioning method(s) in set(s) of assistance data suitable for the corresponding second UE. For example, the set(s) of assistance data suitable for the second UE may be determined from the one or more sets of assistance data (and one or more additional sets of assistance data in some cases) (e.g., determined in step 403). In step 602, each second UE may also calculate a position (or ranging) of the corresponding second UE according to SL-PRS measurement result(s) and set(s) of assistance data suitable for the corresponding second UE.

After a second UE finishes SL-PRS measurement or position calculation (or ranging calculation), in step 603, the second UE may transmit an indication indicating a finish of SL-PRS measurement or position calculation (or ranging calculation) to the first UE. In the example of FIG. 6, UE #2-1 and UE #2-2 may transmit the indication to the first UE, respectively.

In some embodiments, the indication may be transmitted within a time period after a start of a transmission of the one or more sets of SL-PRS. As an example, the time period may be configured by the first UE, e.g., the time period may be included in at least one of: the assistance data message, the additional assistance data message, the one or more sets of assistance data, or the one or more additional sets of assistance data as described above. As another example, the time period may be inferred from a location service QoS requirement for the location request associated with the SLPP session. As yet another example, the time period may be pre-configured or pre-defined.

For a second UE (e.g., UE #2-3) which fails to transmit an indication indicating a finish of SL-PRS measurement or position calculation (or ranging calculation) within the time period, i.e., the first UE does not receive an indication indicating a finish of SL-PRS measurement or position calculation from the second UE within the time period, the first UE may determine a location failure for the second UE.

In some embodiments of the present application, step 603 may not be performed. That is, each second UE does not indicate a finish of SL-PRS measurement or position calculation (or ranging calculation) to the first UE. In such embodiments, the first UE may transmit (e.g., groupcast) an indication indicating an end time of a transmission of the one or more sets of SL-PRS. For example, the end time of the transmission of the one or more sets of SL-PRS may be included in at least one of: the assistance data message, the additional assistance data message, the one or more sets of assistance data, or the one or more additional sets of assistance data as described above. Then, each second UE may autonomously stop measuring SL-PRS at the end time.

According to some embodiments of the present application, the first UE may determine the SLPP session to be terminated in response to at least one of the following:
a stop of a transmission of the one or more sets of SL-PRSs;
receiving indication(s) indicating a finish of SL-PRS measurement or position calculation (or ranging calculation) from all of the one or more second UEs; or
determining that all of the one or more second UEs have finished SL-PRS measurement or position calculation (or ranging calculation), which may include the case that the first UE receives at least one indication indicating a finish of SL-PRS measurement or position calculation (or ranging calculation) from at least one second UE of the one or more second UEs and determines location failure for other UE(s) of the one or more second UEs, or the case that the first UE determines location failure for all of the one or more second UEs.

According to some embodiments of the present application, a second UE of the one or more second UE may determine the SLPP session to be terminated in response to a stop of a transmission of the one or more sets of SL-PRSs.

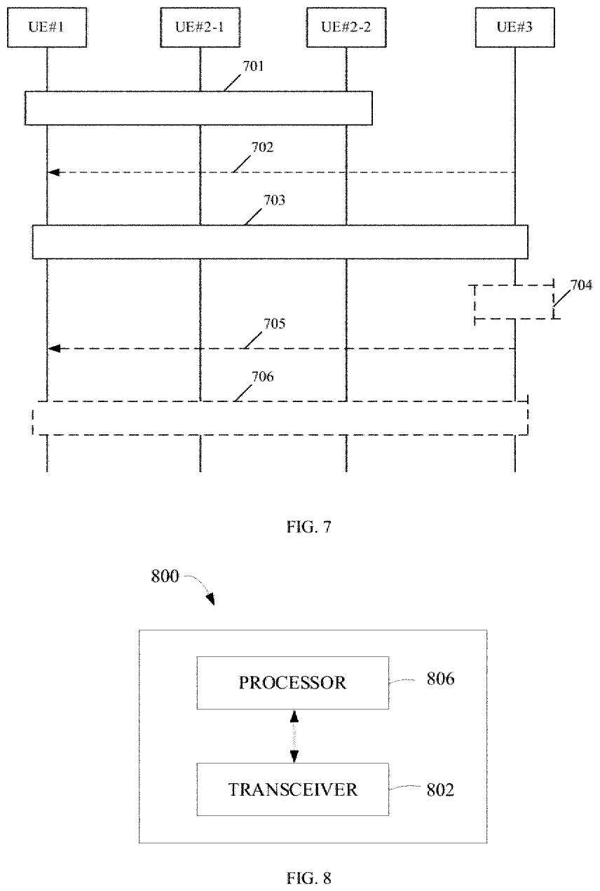

FIG. 7 illustrates an exemplary procedure for group change according to some embodiments of the present application.

The method illustrated in FIG. 7 may be performed by a first UE (e.g., UE #1), one or more second UEs (UE #2-1 and UE #2-2), and a third UE (e.g., UE #3). The first UE may refer to an initiator UE which triggers a procedure, such as a group leader, a server UE, an anchor UE, an SL reference UE, or an SL positioning client UE. The initiator UE may be determined by an upper layer (e.g. application layer). Each second UE may refer to a target UE whose position (or location) needs to be calculated or known. The third UE may refer to a new target UE which joins an on-going SLPP session among the first UE and the one or more second UEs or a group including the first UE and the one or more second UEs. Although two second UEs and one third UE are depicted in FIG. 7 for illustrative purpose, it is contemplated that any number of second UEs and third UEs may be included in FIG. 7. The operations performed by the third UE shown in FIG. 7 may also apply to other third UEs. Although the method is illustrated in a system level by four UEs, persons skilled in the art can understand that the method implemented in the first UE, that implemented in the two second UEs, and that implemented in the third UE can be separately implemented and incorporated by other apparatus with the like functions.

Before the steps shown in FIG. 7, the first UE (e.g., UE #1) and the one or more second UEs (e.g., UE #2-1 and UE #2-2) may establish an SLPP session among them. That is, the first UE may establish an SLPP session with the one or more second UEs, or any second UE of the one or more second UEs may establish an SLPP session with the first UE and other second UE(s) in the one or more second UEs. In other words, the procedure illustrated in FIG. 7 may occur in a case that an SLPP session has been established among the first UE and the one or more second UEs. That is, the first UE and the one or more second UEs are in a group and in the established SLPP session.

Referring to FIG. 7, in step 701, the first UE (e.g., UE #1) and the one or more second UEs (e.g., UE #2-1 and UE #2-2) may have an on-going location procedure in the SLPP session.

The third UE (e.g., UE #3) may join the SLPP session (or the group). After the third UE joined the SLPP session (or the group), in step 702, the third UE may groupcast or unicast a capability message to the first UE. The capability message may include an ID of the third UE. In addition, the definitions regarding a capability message described with respect to FIGS. 2 and 3 may also apply here.

In response to receiving the capability message, the first UE may determine that the capability message is from a new UE based on the ID included in the capability message. Then, in step 703, the first UE may groupcast or unicast assistance data associated with the SLPP session to the third UE. For example, the assistance data may include one or more sets of assistance data (and one or more additional sets of assistance data in some cases) as described with respect to FIGS. 4 and 5.

After receiving the assistance data associated with the SLPP session, the third UE may determine whether the assistance data is suitable for the third UE (e.g., suitable for SL positioning capability of the third UE) and a location service QoS requirement.

In the case that the assistance data is suitable for the third UE, in step 704, the third UE may measure SL-PRS according to the assistance data and calculate a position (or ranging) of the third UE based on SL-PRS measurement result(s) and the assistance data.

In the case that the assistance data is not suitable for the third UE, in step 705, the third UE may transmit an indication to the first UE, wherein the indication may indicate that the assistance data is not suitable or request new assistance data. In response to receiving the indication, in step 706, the first UE may groupcast or unicast new assistance data to the third UE. For example, the new assistance data may indicate configuration(s) of positioning method(s) supported by the third UE.

In some other embodiments of the present application, step 702 may not be performed. The first UE may groupcast or unicast assistance data associated with the SLPP session to the third UE after the third UE joined the SLPP session. In such embodiments, after receiving the assistance data associated with the SLPP session, the third UE may determine whether the assistance data is suitable for the third UE and a location service QoS requirement.

In the case that the assistance data is suitable for the third UE, the third UE may measure SL-PRS according to the assistance data and calculate a position (or ranging) of the third UE based on SL-PRS measurement result(s) and the assistance data in step 704.

In the case that the assistance data is not suitable for the third UE, the third UE may transmit an indication to the first UE in step 705, wherein the indication may indicate that the assistance data is not suitable. Alternatively or additionally, the third UE may transmit a capability message or an assistance data request message to the first UE. In response, the first UE may groupcast or unicast new assistance data to the third UE in step 706. For example, the new assistance data may indicate configuration(s) of positioning method(s) supported by the third UE.

FIG. 8 illustrates a simplified block diagram of an exemplary apparatus 800 for SL positioning according to some embodiments of the present application. In some embodiments, the apparatus 800 may be or include at least part of a UE (e.g., initiator UE or target UE as described above).

Referring to FIG. 8, the apparatus 800 may include at least one transceiver 802 and at least one processor 806. The at least one transceiver 802 is coupled to the at least one processor 806.

Although in this figure, elements such as the transceiver 802 and the processor 806 are illustrated in the singular, the plural is contemplated unless a limitation to the singular is explicitly stated. In some embodiments of the present application, the transceiver 802 may be divided into two devices, such as receiving circuitry (or a receiver) and transmitting circuitry (or a transmitter). In some embodiments of the present application, the apparatus 800 may further include an input device, a memory, and/or other components. The transceiver 802 and the processor 806 may be configured to perform any of the methods described herein (e.g., the methods described with respect to FIGS. 2-7 or other methods described in the embodiments of the present application).

According to some embodiments of the present application, the apparatus 800 may be an initiator UE, and the transceiver 802 and the processor 806 may be configured to perform operations of an initiator UE in any of the methods as described with respect to FIGS. 2-7 or other methods described in the embodiments of the present application. For example, the processor 806 is configured to: establish an SLPP session with multiple target UEs; and receive, with the transceiver 802, multiple capability messages from the multiple target UEs, wherein each capability message in the multiple capability messages indicates SL positioning capability information of a corresponding target UE in the multiple target UEs.

According to some embodiments of the present application, the apparatus 800 may be a target UE, and the transceiver 802 and the processor 806 may be configured to perform operations of a target UE in any of the methods as described with respect to FIGS. 2-7 or other methods described in the embodiments of the present application. For example, the processor 806 is configured to: establish an SLPP session with an initiator UE and one or more other target UEs; and groupcast or unicast, with the transceiver 802, a capability message to the initiator UE, wherein the capability message indicates SL positioning capability information of the target UE.

In some embodiments of the present application, the apparatus 800 may further include at least one non-transitory computer-readable medium. In some embodiments of the present disclosure, the non-transitory computer-readable medium may have stored thereon computer-executable instructions to cause the processor 806 to implement any of the methods as described above. For example, the computer-executable instructions, when executed, may cause the processor 806 to interact with the transceiver 802, so as to perform operations of the methods, e.g., as described with respect to FIGS. 2-7 or other methods described in the embodiments of the present application.

The method according to any of the embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for SL positioning, including a processor and a memory. Computer programmable instructions for implementing a method for SL positioning are stored in the memory, and the processor is configured to perform the computer programmable instructions to implement the method for SL positioning. The method for SL positioning may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for SL positioning according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A second user equipment (UE), comprising:
at least one memory; and
at least one processor coupled with the at least one memory and configured to cause the second UE to:
establish a sidelink (SL) positioning protocol (SLPP) session with a first UE and one or more other second UEs; and
groupcast or unicast a capability message to the first UE, wherein the capability message indicates SL positioning capability information of the second UE.

2. The second UE of claim 1, wherein the capability message includes at least one of:
an identity (ID) of the second UE;
an ID of the first UE;
an ID of an SLPP transaction within the SLPP session; or
an ID of the SLPP session.

3. The second UE of claim 1, wherein the at least one processor is configured to cause the second UE to receive a capability request message groupcast from the first UE for requesting the SL positioning capability information, and the capability request message includes at least one of:
an ID of the first UE;
an ID of an SLPP transaction within the SLPP session;
an ID of the SLPP session; or
a response time within which the second UE is required to respond with the SL positioning capability information.

4. The second UE of claim 1, wherein the at least one processor is configured to cause the second UE to trigger a transmission of the capability message in response to at least one of the following:
receiving an indication from an upper layer indicating an establishment of the SLPP session or an establishment of a group including the first UE and the second UE; or
joining the SLPP session or the group; or
wherein the capability message is transmitted via a discovery message associated with a discovery procedure between the first UE and the second UE.

5. The second UE of claim 1, wherein the at least one processor is configured to cause the second UE to:
receive an assistance data message including one or more sets of assistance data groupcast from the first UE, wherein each set of assistance data indicates a corresponding configuration of a corresponding positioning method.

6. The second UE of claim 5, wherein the at least one processor is configured to cause the second UE to:
transmit, to the first UE, an assistance data request message for requesting configuration(s) of positioning method(s).

7. The second UE of claim 6, wherein the at least one processor is configured to cause the second UE to trigger a transmission of the assistance data request message in response to an SLPP transaction for capability transfer in the SLPP session being finished.

8. The second UE of claim 6, wherein the at least one processor is configured to cause the second UE to determine at least one set of assistance data from the one or more sets of assistance data that is suitable for the second UE or matches the assistance data request message transmitted by the second UE.

9. The second UE of claim 5, wherein, in response to the one or more sets of assistance data not being suitable for the second UE, the at least one processor is configured to cause the second UE to:
indicate the one or more sets of assistance data to an upper layer for determining to use at least one set of assistance data of the one or more sets of assistance data; or
transmit an indication to the first UE, wherein the indication indicates that the one or more sets of assistance data are not suitable for the second UE or includes an assistance data request message for requesting configuration(s) of positioning method(s) for the second UE.

10. The second UE of claim 9, wherein the at least one processor is configured to cause the second UE to:
receive an addition assistance data message including one or more additional sets of assistance data groupcast from the first UE or an indication indicating that no new assistance data can be provided to the second UE.

11. The second UE of claim 5, wherein the at least one processor is configured to cause the second UE to:
receive one or more sets of SL positioning reference signals (SL-PRSs) groupcast or broadcast from the first UE according to the one or more sets of assistance data; and
measure SL-PRS according to configuration(s) of positioning method(s) in set(s) of assistance data suitable for the second UE and calculate a position of the second UE according to SL-PRS measurement result(s) and the set(s) of assistance data suitable for the second UE.

12. The second UE of claim 11, wherein the at least one processor is configured to cause the second UE to:
transmit an indication to the first UE within a time period after a start of a transmission of the one or more sets of SL-PRSs;
wherein the indication indicates a finish of SL-PRS measurement or position calculation of the second UE; and
wherein the time period is configured by the first UE or inferred from a location service quality of service (QoS) requirement or pre-configured or pre-defined.

13. The second UE of claim 11, wherein the at least one processor is configured to cause the second UE to receive an indication indicating an end time of a transmission of the one or more sets of SL-PRSs, and stop measuring SL-PRS at the end time.

14. The second UE of claim 1, wherein establishing the SLPP session with the first UE and the one or more other second UEs includes joining an SLPP session previously established between the first UE and the one or more other second UEs, the capability message includes an ID of the second UE, and the at least one processor is configured to cause the second UE to:
receive assistance data associated with a previously established SLPP session groupcast or unicast from the first UE in response to the capability message.

15. A method performed by a second user equipment (UE), the method comprising:
establishing a sidelink (SL) positioning protocol (SLPP) session with a first UE and one or more other second UEs; and
groupcasting or unicasting a capability message to the first UE, wherein the capability message indicates SL positioning capability information of the second UE.

16. A processor of a second user equipment (UE) for wireless communication, the processor comprising:
at least one controller coupled with at least one memory and configured to cause the processor to:
establish a sidelink (SL) positioning protocol (SLPP) session with a first UE and one or more other second UEs; and
groupcast or unicast a capability message to the first UE, wherein the capability message indicates SL positioning capability information of the second UE.

17. The processor of claim 16, wherein the capability message includes at least one of:
an identity (ID) of the second UE;
an ID of the first UE;
an ID of an SLPP transaction within the SLPP session; or
an ID of the SLPP session.

18. The processor of claim 16, wherein the at least one controller is configured to cause the processor to receive a capability request message groupcast from the first UE for requesting the SL positioning capability information, and the capability request message includes at least one of:
an ID of the first UE;
an ID of an SLPP transaction within the SLPP session;
an ID of the SLPP session; or
a response time within which the second UE is required to respond with the SL positioning capability information.

19. The processor of claim 16, wherein the at least one controller is configured to cause the processor to trigger a transmission of the capability message in response to at least one of the following:
receiving an indication from an upper layer indicating an establishment of the SLPP session or an establishment of a group including the first UE and the second UE; or
joining the SLPP session or the group; or
wherein the capability message is transmitted via a discovery message associated with a discovery procedure between the first UE and the second UE.

20. The processor of claim 16, wherein the at least one controller is configured to cause the processor to:
receive an assistance data message including one or more sets of assistance data groupcast from the first UE, wherein each set of assistance data indicates a corresponding configuration of a corresponding positioning method.
